(19) United States
(12) Patent Application Publication
(10) Pub. No.: US 2005/0072442 A1
(43) Pub. Date: Apr. 7, 2005

(54) Self-contained hair-coloring system for touch-up, highlighting and less than full treatment applications

(76) Inventors: Louis Licari, New York, NY (US); Carla Nugent, New York, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 10/369,116

(22) Filed: Feb. 19, 2003

Related U.S. Application Data
(60) Provisional application No. 60/358,449, filed on Feb. 20, 2002.

(51) Int. Cl. A45D 24/22; B67D 5/06; B65D 35/22

(52) U.S. Cl. 132/112; 222/94; 222/129; 222/192; 132/116; 401/196

(57) ABSTRACT

A hair coloring system for hair coloring applications such as touch-up and highlighting. The system comprises a multi-component hair color and a closed container that separately stores the hair color components, and provides for mixing the components prior to use within the same container, and then for applying the mixed components directly from the container to hair to be colored through passage(s) in the container that are opened after the components have been mixed. The passage(s) may be configured, for example by an attachment, such as a spatula, brush or sponge, for direct application of the hair color to hair. A closed system is provided that eliminates the risk of spillage during storage, preparation and use of multi-component hair colors. The system is self-contained in the sense that the hair color is supplied as part of a device that stores components of the hair color, mixes the components and provides for directed delivery of the mixed hair color.

This application claims the benefit of U.S. provisional application No. 60/358,449, filed Feb. 20, 2002, the disclosure of which is incorporated herein by reference.

### BACKGROUND OF THE INVENTION

The invention disclosed herein relates to hair-coloring and a system for storing, mixing and applying a multi-component hair color directly to hair to be colored. The invention provides both a system or device and a method.

The invention is concerned with the storage, mixing and direct application to hair to be colored of limited amounts of multi-component hair colors for touch-up (e.g., a minor interim treatment that is performed between full color treatments at the hair roots or elsewhere), highlighting, facial hair coloring and other applications other than a full treatment hair coloring.

U.S. Pat. Nos. 6,247,586, 5,778,902 and 5,937,864 disclose devices that hold two components of a two-component hair color separately, and provide for mixing the components prior to application thereof to hair to be colored.

### SUMMARY OF THE INVENTION

The invention provides a hair coloring system for hair coloring applications such as touch-up, highlighting, coloring facial hair and the like. The system comprises a multi-component hair color and a device that includes a closed container that separately stores therein the components of the multi-component hair color hair, and provides for mixing the components prior to use within that same closed container (without opening the container), and then applying the mixed components directly from that same previously closed container to hair to be colored through an opening made that can be made in the container after the components have been mixed. In preferred embodiments, the opening is configured for a directed application of the hair color directly to hair, and may include an applicator such as a spatula, brush or sponge, for example.

The closed system provided by the invention eliminates the risk of spillage while storing the multi-component hair color and while preparing the multi-component hair color for use. With a configured opening, the system also reduces the risk of spillage during application of the hair color as well as facilitates application and enables improved application of hair color for the concerned hair coloring applications.

Also, devices according to the invention can be manufactured relatively inexpensively so as to be marketable as disposable, single application or use devices.

In the preferred embodiments, the container is elongated, self-supporting, e.g., does not collapse or excessively bend under its own weight, and sized to be grasped by a fingers of a hand or against the palm of a hand, e.g., approximately the size of a pencil, pen, or cigar.

The invention provides for application of hair color to all hair types, and for both men and women. Examples of hair color changes that may be achieved include color variations within a wide range of the color and shade spectrum, highlighting, total gray coverage, and partial or selective color changes. A consumer may touch up selected hairs that are gray, for instance. The invention may also be used to paint out gray streaks that typically occur in certain areas of the scalp.

Any suitable hair color may be used as the multi-component hair color, for example, hair colors that comprises at least one dye and at least one an activator, e.g., peroxide. Multi-component hair colors are known in the art of hair coloring. The hair color may be conventional, and the viscosities of the hair color components may be selected to produce, when mixed, a hair color that has desired flow characteristics for a particular application. For example, for touch-up applications, the viscosities may be selected to produce a mixture that does not quickly run and yet is easily spread, preferably by an applicator associated with the container. However, for highlighting applications, the viscosities may be selected to produce a mixture that can be smoothly ejected from the container, perhaps more quickly than for root touch-up applications as the device is passed more quickly over longer stretches of hair.

In the preferred embodiments, the components of the hair color are liquids, but may be gels or creams, or one of the components may be a powder that is dissolved by or mixed with another component that is a liquid or gel, etc.

Various structures may provide for separate storage of the components and mixing of the components within the closed container, and for applying the mixed components directly from the container to hair to be colored. Suitable structures (a) maintain the hair color components separate under handling expected for a product of this type prior to the time the hair coloring system is to be used, e.g., during shipment after manufacture, while stored in inventory, while on the shelf for sale, while transported and stored by a consumer, etc., (b) communicate the components within the closed container in response to manual actions applied to the unitary container, e.g., manual squeezing, twisting, bending actions, etc., and (c) permit mixing of the communicated components within the closed container in response to manual actions applied to the container such as shaking, kneading, etc. Examples of suitable structures are disclosed herein. U.S. Pat. Nos. 4,061,910, 5,043,851, 5,067,051, 5,488,544, 6,283,933, and 6,189,688 disclose subject matter, outside the field of hair coloring, that may have application to the devices disclosed herein. The disclosures of these patents are incorporated herein by reference.

In one embodiment, two parts of the container, separated by a movable or breakable (rupturable, fracturable, frangible, etc.) sealing member(s) (or sealed wall(s)) of the container, each hold a component of the hair color. In another embodiment, a breakable glass, plastic, film or foil ampoule, vial, packet or pouch, holding one component, occupies part of the container interior. (The term “ampoule” is used herein in a broad sense and encompasses vials, pouches, sealed plastic film and foil packets as well as thin glass and plastic containers, etc., and is not limited to containing only a single dose or use of a component.) Another component is held in the container interior either in another breakable ampoule or directly such that breaking the ampoule or ampoules communicates the two components in the interior of the container. To facilitate breaking, an ampoule may be provided with a weakened portion or fracture area, etc.

The container may itself be flexible or deformable, or include a region that is flexible or deformable, so that a manual action applied thereto can move a sealing member or break a sealing member or an ampoule. The interior of the container is sized and the degree of component filling is selected to permit mixing of the communicated components under the application of manual actions such as shaking or kneading, etc. Since the inventive hair coloring system is self-contained, and the components are stored, communicated and mixed entirely within a closed container, and then applied directly through a preferably directed opening made in the container to hair to be colored, with the exercise of routine care, there is little risk that any of the hair color will leak onto ones hands or clothing or on anything else.

The container is thus reconfigurable by a user from a storage configuration, in which the ingredients are maintained separately in the container and are precluded from mixing, to a ready-to-use configuration, in which the ingredients are allowed to mix within the container to form the hair color.

In the preferred embodiments, when the components are communicated, all of the components stored in the container are exposed to each other. Thus, in the preferred embodiments, the hair coloring system is a single use system, and preferably includes a single use amount of the components. The system is preferably not refillable and thus is disposable. However, hair color in a device according to the invention need not be used in one application and can be saved in the device and used at a later time while the hair color is still effective.

The invention provides various directed release structures for applying the hair color to the hair, including single and multiple spout or nozzle embodiments, as well as applicators such as a brush, spatula, or sponge that can be unitary with or attachable to an inventive container.

In one embodiment, a portion of the walls of the container are sealed together in a sealing region using, e.g., an adhesive or a heat seal or ultrasonic weld, to form separate chambers in the container for separately maintaining the hair color components. In this embodiment, the container is reconfigured into the ready-to-use configuration by breaking the seal in the sealing region, thereby enabling the hair color components to be mixed in the closed container The seal can be broken by the application of pressure applied by fingers of a hand, for example.

In another embodiment, the container houses a pouch or bag, e.g., made of plastic or foil, having separate chambers for maintaining the hair color components separately, which is reconfigured into the ready-to-use configuration by rupturing a seal in the pouch between the two chambers. The pouch may be formed by two sheets that are sealed at their edges, e.g., by a heat seal that is stronger than the seal in the sealing region so that the seal in the sealing region breaks before the seal along the edges of the sheets can break. The seal in the sealed region may use be formed by a sealing member or material, e.g., wax or paraffin material, that can be dislodged before the seal along the edges of the sheets breaks.

In one embodiment, a self-supporting outer container and an inner container (self-supporting or not) are provided. Directed delivery may occur directly from the inner container through an opening in the outer container, or from the inner container to the outer container, and from the outer container through an opening thereof.

In some embodiments, a plurality of containers are attached together to provide a system with a plurality of hair colors that may be the same, partially different or entirely different. The plurality of attached containers may be provided as inner containers in an outer container. Inner containers may be self-supporting or not. Non-self-supporting containers may be made of plastic film or foil similar to condiment packages, such as ketchup, for take out food.

The container may be formed in different ways, such as by extrusion or injection molding, and the hair color components may be provided in the container in various ways, e.g., discussed below.

An applicator, such as a brush, sponge or spatula, may be associated with the directed release portion of the container for applying the hair color directly to hair. The applicator may be unitary with the container, or the container may have structure for attaching an applicator thereto.

The directed release portion of the container may have different configurations, such as a nozzle having a tab that is adapted to be ruptured by the user by bending, a score line that is adapted to be ruptured by the user by tearing, or a cut line that is adapted to be ruptured by the user by cutting.

A method according to the invention comprises separating hair color components in a closed container, communicating the hair color components in the closed container, mixing the communicated hair color components in the closed container and providing an opening in the closed container through which the mixed components can be directly applied to hair.

### BRIEF DESCRIPTION OF THE DRAWINGS

The invention is illustrated in the figures of the accompanying drawings, which are exemplary, in which like and corresponding references in different figures indicate like, similar or corresponding parts, and in which:

FIG. 1 is a perspective view of a hair coloring device or system according to the invention showing a tubular container in which a sealing member separates two parts of the container, each holding a different hair color component;

FIG. 2 is a cross section view of the device depicted in FIG. 1 taken along line 2-2 in FIG. 1 and also showing the container being compressed to move the sealing member and communicate the two parts of the container;

FIG. 3 is a perspective view of the device depicted in FIG. 1, after the sealing member has been moved and the end of the tubular member snipped to open a spout or nozzle thereat, in use applying hair color to hair at the roots thereof in a touch-up application;

FIG. 4 is a perspective view of a hair coloring device or system according to another embodiment of the invention showing a tubular container in the interior of which is an ampoule that holds one component of a hair color and a different component of the hair color outside of the ampoule;

FIG. 5 is a cross section view of the device depicted in FIG. 4 taken along line 5-5 in FIG. 4 and also showing the container being compressed to rupture the ampoule and communicate the two components of the hair color;

FIG. 6 is an exploded side view of a hair coloring device or system according to another embodiment of the invention similar to the embodiment depicted in FIG. 4, also including an attachable brush applicator;

FIG. 7 is a side view of an attachable sponge applicator for the device depicted in FIG. 6;

FIG. 8 is a longitudinal section view of a hair coloring device or system according to another embodiment of the invention showing two attached devices, each of which is similar to the device depicted in FIG. 1 and can hold a different (or the same) hair color;

FIG. 9 is a cross section view of the device depicted in FIG. 8 taken along lines 9-9 of FIG. 8;

FIG. 10 is a longitudinal section view of a hair coloring device or system according to another embodiment of the invention similar to the embodiment depicted in FIG. 4, except that a grate is provided to hold the ampoule in place and prevent passage of broken parts of the ampoule therethrough and structure is provided in the container that assists in breaking the ampoule;

FIG. 11 is a cross section view of the device depicted in FIG. 10 taken along lines 11-11 in FIG. 10;

FIG. 12 is a side view of a hair coloring device or system according to another embodiment of the invention showing an outer container holding an inner container similar to the container depicted in FIG. 4 except that the ampoule is held in a forward or downstream part of the container, and the container is shaped;

FIG. 13 is an right end view of the device depicted in FIG. 12;

FIG. 14 is a side view, partly broken away, of a hair coloring device or system according to another embodiment of the invention showing a shaped container similar to the container within the outer container depicted in FIG. 12;

FIG. 15 is an exploded side view of a hair coloring device or system according to another embodiment of the invention showing a container similar to the container depicted in FIG. 14 also including an attachable brush applicator similar to the applicator depicted in FIG. 6;

FIG. 16 is a side view of a hair coloring device similar to the device depicted in FIG. 14 and including structure on the outer container for attaching an attachable applicator device;

FIG. 17 is a right side view of the device depicted in FIG. 16;

FIG. 18 is an axial cross section view of the device depicted in FIG. 16;

FIG. 19 is a side view of the device depicted in FIG. 16 with a sponge applicator attached thereto;

FIG. 20s a side view of the device depicted in FIG. 12 having three spouts at the end thereof instead of one spout;

FIG. 21 is a side view of a hair coloring device or system according to another embodiment of the invention showing two interior containers similar to the container depicted in FIG. 12 but attached similar to the containers depicted in FIG. 8 in an outer container similar to the container depicted in FIG. 12;

FIG. 22 is a longitudinal section view of a hair coloring device or system similar to the device depicted in FIG. 1 showing a different sealing member arrangement;

FIG. 23 is a cross section view of the device depicted in FIG. 22 taken along line 23-23 in FIG. 22;

FIG. 24 is a longitudinal section view of a portion of the device depicted in FIG. 22 showing displacement of the sealing member cause by squeezing the container; and

FIG. 25 is a cross section view of the dispensing end of the device depicted in FIG. 24 according to another embodiment.

### DETAILED DESCRIPTION OF PREFERRED EMBODIMENTS

Many formulations for hair color provide a color to the hair that can last up to several weeks, depending on factors such as the hair type, dye color, exposure to sunlight and chlorine and other factors. Generally, such hair colors comprise two or more components that are stored separately until the hair color is to be used, and typically include a dye or colorant component and an activator component, e.g., developer, such as hydrogen peroxide. When the hair color is to be applied, the components are mixed together and applied to the hair to be colored. Such hair colors are typically referred to as “permanent” hair colors. The invention is applicable to such hair colors and other hair colors which comprise two or more components that are stored separately and are mixed together at the time the hair color is to be applied to the hair to be colored.

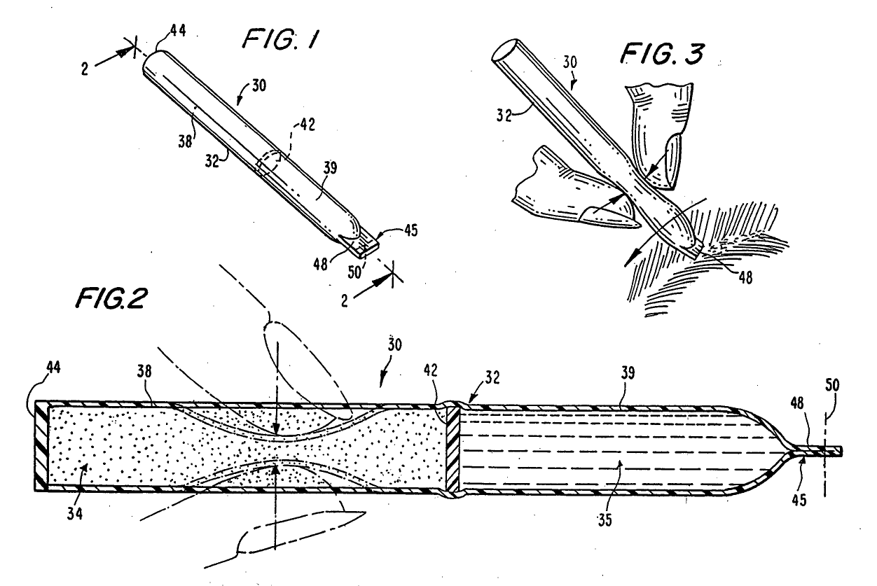

Referring to FIGS. 1-3, a hair coloring device or system 30 according to one embodiment of the invention comprises an elongated container 32 in which two components 34 and 35 (FIG. 2) are stored separated from each other in container parts 38 and 39 of the container 32. In a preferred embodiment, the container 32 is tubular, but the container can have any suitable shape, for example, contoured shapes as exemplified by the device depicted in FIG. 15, or of rectangular, polygonal, oval, etc. cross section. Generally, the container 32 has a shape that can be easily held and manipulated by a user in one hand. The container 32 is self-supporting, e.g., does not appreciably fold or flop under its own weight. The device 30 depicted in FIGS. 1-3 is sized to be grasped between fingers of a hand, as illustrated by FIGS. 2 and 3, but can be larger or smaller. For example, the device 30 may be of pencil, fountain pen, or cigar size. As illustrated in FIG. 3, the container 32 does not appreciably bend when supported between fingers of a hand or when pressed against the hair or scalp during application of hair color to the hair.

Although containers used in the invention may have any suitable shape, the following description discusses containers of tubular or generally tubular shape with the understanding, however, the description applies directly or correspondingly to containers of other shape and that the use in the invention of containers of other shapes will be apparent to those of skill in the relevant art.

In the embodiment depicted in FIGS. 1-3, a disc-shaped sealing member 42 seals against the interior periphery (circumference) of the container 32. A seal may be provided in any suitable way. In the preferred embodiment, the container 32 and the member 42 are made of plastic, e.g., a monolayer polyethylene, PTFE (Teflon) or any other suitable material, and a seal of member 42 in the container may be made by, e.g.: a tight or interference mechanical fit of the member 42 obtained for example by forcing a member having a larger diameter than the inner diameter of the container into position or by reducing the inner diameter of the container along the periphery of the member 42 after the member is in position; heat weld or seal; an ultrasonic weld; an adhesive; forming the member 42 unitary with the container 32; etc. (Filling the container with components 34 and 35 is discussed below.) In one embodiment, the sealing member 42 may comprise a generally rigid piece of plastic such as a washer or disk, which may be referred to as a “flip disk,” that is sealingly held in place against the inner container wall. The container wall may have a circumferential groove or recess in which the outer periphery of the sealing member 42 is engaged and sealed.

The sealing member 42 forms a fluid-tight seal (with respect to the components 34 and 35) against the container and thereby separates the components 34 and 35 in the container 32. The container 30 is similarly made of a material that fluid-tight with respect to air and the components 34 and 35. In other words, member 42 and container 32 are essentially impermeable to air and the components 34 and 35 over at least the expected shelf life of the device 30. (The terms “fluid-tight” and “impermeable” are meant in a relative sense, as discussed above, unless the context indicates otherwise.)

The ends 44 and 45 of the container 32 are closed fluid-tight in any suitable manner, e.g., crimping, heat weld or seal, an ultrasonic weld, by an adhesive, etc. The container 32 may be filled with components 34 and 35 in any suitable manner, e.g., by sealing an end, dispensing on of the component into the part 38 or 39 adjacent the sealed end to a level below the position of member 42, sealing member 42 against the container, filling the other part of the container and sealing the other end of the container. The container may be filled from one end after the member 32 has been sealed against the container followed by sealed that end, and filling from and sealing the opposite end. The container may also be filled after it has been fully closed by injecting the components into the parts 38 and 39 and thereafter sealing the injection holes.

The end 45 is sealed to so as to provide for an opening and directed delivery of hair color therethrough from within the container 32. For example, end 45 provides a spout (or nozzle) and/or an applicator 48. Referring to FIGS. 1 and 3, the end 45 of the container is sealed flat at least at the outer edge thereof. A spout can be formed in end 45 using e.g., a die plate. When the hair color is to be applied to hair, the end 45 is snipped, cut, broken, etc., along the broken line 50, which may be marked on the end 45. The end 45 may be weakened, bent, scored, etc. along line 50 to facilitate breaking the edge of the end 45 off without a scissors or other tool or implement.

Breaking off the edge of the end 45 either provides a wider, flat spout (or nozzle) in communication with the interior of the container 32, or a smaller more directed spout or nozzle in the container end 45. In either case, squeezing the container 32, as illustrated in FIG. 2, forces hair color out of the container through this spout. (In the case where the end 45 of the container is still sealed, squeezing the container forces the end 45 open.)

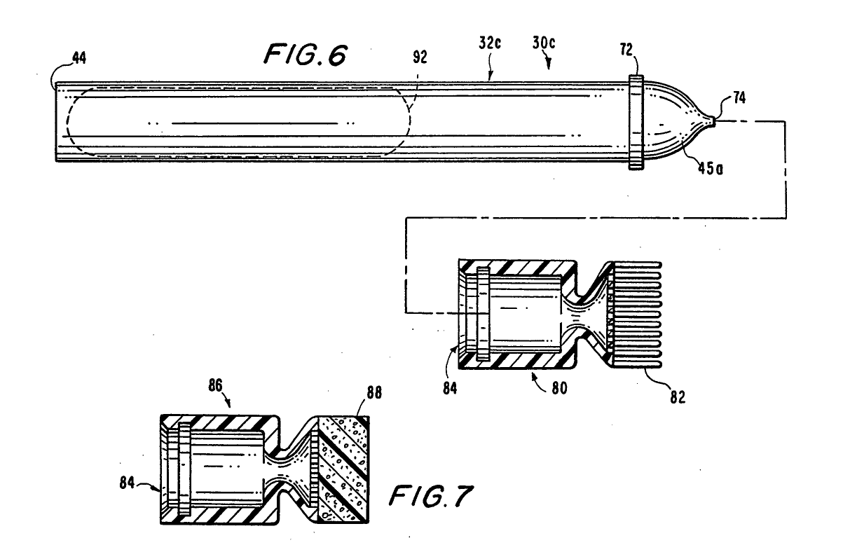

The flat outer part of the end 45 functions as an applicator in the form of a spatula. Referring to FIG. 3, the hair color is squeezed out of the spout in the end 45 of the container and spread or applied to hair at the roots thereof near the scalp by the flattened end 45 functioning as a spatula. Other applicators are disclosed below, and particular applicators may be better suited to apply hair color to hair for different applications such as touch-up, highlighting, coloring facial hair, etc. For example, in the device 30c depicted in FIG. 6, a smaller diameter tubular or conical spout 72 is provided, and similar spouts are provided in the devices depicted in FIGS. 12-22. Similarly, different applicators may be communicated with the various spouts. For example, a brush applicator 80 and a sponge applicator 86, as illustrated, for example, in FIGS. 6 and 7, may be used.

Hair color from the device 30 can be applied in a directed manner by a consumer to the root or other hair portions. Because the device 30 enables a directed application of hair-color, such application can be made, e.g., to root portions. The device 30 as constructed can be run through a person's hair to apply coloring to the desired hair portions, and a person can apply hair color from a device 30 directly to her or his hair or to the hair of another person.

As discussed above and illustrated in FIG. 3, device 30 is well suited to touch-up applications. Devices having a tubular spout, or a brush or sponge applicator may be better suited to highlighting applications, etc., and devices having a brush or sponge applicator may also be suitable for root touch-up applications, etc.

Referring to FIG. 2, the components 34 and 35 of the hair color are maintained separated in container parts 38 and 39, respectively, by the sealing member 42. Either component of a two-component hair color may be stored in part 38 and 39. When it is desired to apply the hair color in device 30 to the hair, the components 34 and 35 are communicated and mixed, i.e., the seal between container parts 38 39 is broken. This may be accomplished in different ways depending upon structure of the sealing member 42 and the nature of the seal between the sealing member 42 and the container 32.

In one embodiment, the seal is broken simply by squeezing container part 38, as illustrated in FIG. 3. The force created by squeezing either ruptures the sealing member 42 or dislodges it at least partially from the sealing position depicted in FIG. 2. (The container could also be squeezed at container part 39 to break the seal, but this is not preferred because of a risk of prematurely breaking the seal at the end 45 of the container.) In other embodiments, a shearing force may be applied generally longitudinally to the container at the location of the sealing member to cause the sealing member to pivot or rotate about a longitudinal axis, or the container may be stricken against an edge of an object such as a counter top at the location of the sealing member. The container may be marked on the outside to indicate a preferred location to squeeze, manipulate or strike the container.

After the container parts 38 and 39 have been communicated, the device may be considered reconfigured from a storage configuration to a use configuration. The components 34 and 35 are mixed together by shaking the device 30 and/or by alternatingly squeezing parts of the container, e.g., to produce a kneading action. Although not shown in FIG. 3, container parts 38 and 39 may not be completely filled to facilitate mixing. A weighted object such as metal ball may be provided in the container 32 enhance the mixing action. Preferably, the container has optical properties that permit the separation or mixing condition of the components within the container. For example, a transparent container allows the condition of the sealing member 42 to be observed as well as the state of mixing of the components 34 and 35. After the components 34 and 35 have been mixed, the end 45 is snipped as discussed above, the mixed hair color applied as shown, for example, in FIG. 3.

The components 34 and 35 my both be liquid or gel, or one may be a powder and the other a liquid or gel. The viscosities of liquid and gel components are selected to provide a smooth ejection of mixed hair color from the container from a squeezing action, e.g., as illustrated in FIG. 3. Particular multi-component hair colors and viscosities of liquid and gel components thereof and will be apparent to those of skill in the art in view of the particular device and the particular hair coloring application. The relative amounts of the two components 34 and 35 will depend upon the hair color and/or the application, and will be known to those of skill in the art. The location of the sealing member 42 will be positioned accordingly.

To accommodate the squeezing described above for breaking the seal between container parts 38 and 39, for mixing the components and for dispensing the mixed hair color, the container is constructed accordingly. For example, the particular material of which the container is constructed, and the thickness of the material are selected to accommodate such squeezing. Alternatively, only portions of the container may be constructed to accommodate such squeezing.

A plastic container 32 may be formed, e.g., by an extrusion or injection molding process. Extrusion provides low cost tubing that can be cut at sealed at opposite ends, as discussed above. Injection molding allows more freedom in the shape and appearance of the device, but may be more expensive. The particular method by which the container 32 is made will influence the manner in which it is filled, as will be apparent to those of skill in the art. The materials of which the container 32 and member 42 may be made, the manner in which the container may made, sealed and filled will be known to those of skill in the art. Similarly, the materials of which containers of other embodiments and structure associated therewith may be made, the manner in which the containers of other embodiments may made, sealed and filled will be known to those of skill in the art, and only limited description will be made to such details in the descriptions below of the other embodiments.

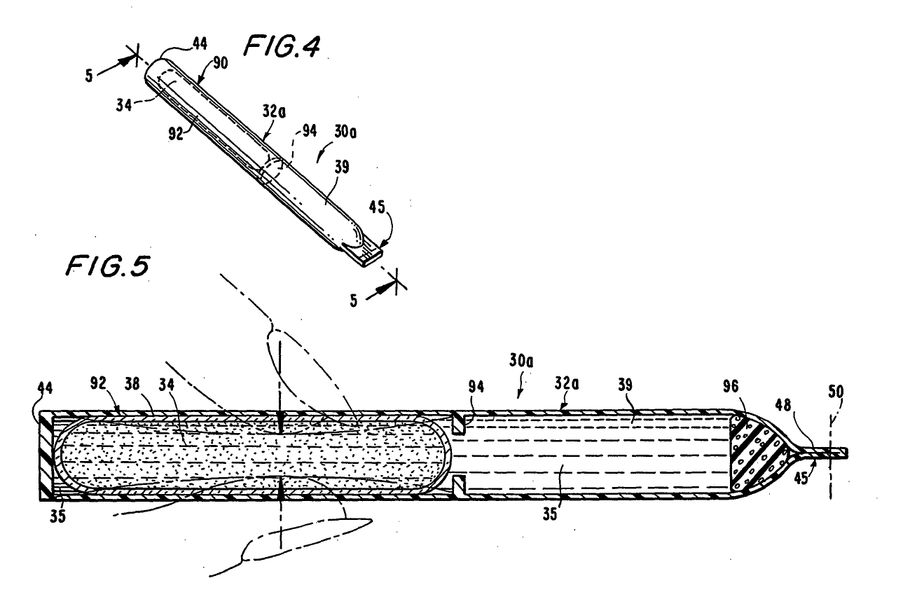

The hair color system or device 32a depicted in FIGS. 4 and 5 is similar to the device 30 depicted in FIGS. 1-3, but includes a breakable or frangible ampoule 92 that defines the container part 38 in which the hair color component 34 is stored. The container part 35 lies outside of the ampoule 92 and stores the hair color component 35. A stop 94 may be provided to limit movement of the ampoule 90 within the container 32a to facilitate breaking the ampoule. Other structure, e.g., a tapered region of the container, or a bonding, e.g., by an adhesive, of the ampoule to the container or other structural or adhesive elements to prevent the vial from shifting, and/or to allow the container to be easily gripped, as discussed further below. A filter 225 made of a mesh or other material may be provided to contain broken fragments of the vial 130 in the container.

When it is desired to apply hair color, the container 32a is squeezed as illustrated in FIG. 5 until the ampoule 92 breaks. Thereafter, the components 34 and 35 are mixed and dispensed as described above. To facilitate breaking of the ampoule 92, the ampoule may be provided with a weakened portion (not shown), e.g., scored, etc.

The ampoule 92 may be made of thin glass or plastic, e.g., a small plastic pouch or tube positioned adjacent end. In either case, the ampoule is constructed to break, rupture, fracture, etc. in response to the squeezing action illustrated in FIG. 5, or other action described above. For example, the glass and its thickness may be selected to easily fracture, and the plastic and/or the sealing mechanism to easily rupture. A filter 96, e.g., a foam sponge, may be provided adjacent end 45 to block or entrain any broken glass of a glass ampoule that progresses to the end 45. In another embodiment, the ampoule 92 is positioned adjacent end 48.

In another embodiment, an ampoule of suitable size similar to ampoule 92 may also be provided for component 35 and positioned adjacent container end 45 to define container part 39. This ampoule may be broken as described above.

FIG. 6 illustrates an embodiment of a hair-coloring device or system 30c that includes attachable applicators 80 (FIG. 6) and 86 (FIG. 7). Various applicators, such as applicator 80 having a brush 82, applicator 86 having a sponge 88, a spatula (not shown, but similar to end 45 in the device 30) may be used to optimally apply the hair color from a hair-coloring device according to the invention. Referring to FIGS. 6 and 7, snap-attachment structure may be provided for attaching a desired applicator. Such structure may comprise an annular shoulder or flange near in or adjacent the end 45a and socket structure in an open end of the respective applicator opposite the applicator tip. Threaded arrangements and other arrangements may be used to attach the applicators, or an applicator can be a unitary part, e.g., integrally molded, with the container 32b.

A spout 74 (FIG. 6) formed in the end 45a of the container 32b communicates with the opening 84 in the applicator 80, 86. The spout 74 is generally tubular or conical and device 70 can be used without an attachable applicator, i.e., the spout 74 may comprise the applicator. The shoulder 72 can be formed with the container 32b or subsequently attached thereto. A generally spherical end 45a and a generally tubular or conical spout 74 may be formed in an injection molding or extrusion process in known manner.

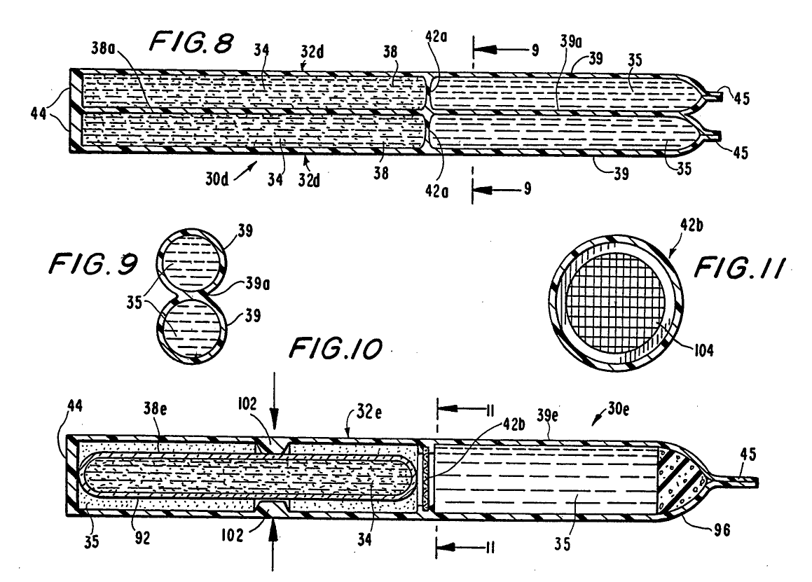

The dual hair coloring system or device 30d depicted in FIGS. 8 and 9 includes two hair colors which may be the same or different. For example, two different shades of a color or two different highlights, or dimensional highlights, or a highlight and a lowlight, or a highlight or color and a contour, etc., may be provided in the same device. Interesting effects such as different colored streaks may be achieved when hair color is dispensed from the two containers together, or the hair colors may be dispensed at different times. In construction, device 32 may comprise a pair of containers 32d, and other containers or devices disclosed herein, attached together.

In the embodiment depicted in FIGS. 8 and 9, the hair coloring device or system 30d includes two attached devices similar to device 30 (with corresponding reference numbers shown). The two containers 32d share a common wall portion 38a, 39a. The sealing members 42a are shown as unitary with the respective container 32d, and have a tapered thickness to facilitate rupturing thereof in response to squeezing the respective container 32d. The device 30d may incorporate any of the applicators, nozzles, component separation structure (e.g., ampoules) disclosed herein in place of the corresponding structure shown in FIGS. 8 and 9. Individual labeling or other markings may be provided for the respective containers 32d. More than two attached devices may be provided, and the devices need not be attached.

The hair coloring system or device 30e depicted in FIG. 10 includes an ampoule 92, a filter 96, an end 45, as in device 30b depicted in FIG. 4, and also includes a screen or grate 42b, which also functions to restrict movement of the ampoule 92, and structure for assisting in breaking the ampoule 92. The break structure 102 projects inwardly from the inner part of the container 32e to the ampoule 92. Squeezing the container 32e at the location of the break structure 102, as indicated by the arrows, assists in breaking the ampoule 92. The break assist structure 102 may be shaped, e.g., have pointed or sharp tips or edges, to further assist in breaking the ampoule 92. Ampoules constructed as plastic pouches or films or foils may be more in need of such structure than a glass ampoule to easily break the ampoule. The screen 42b functions to maintain the ampoule in place and to prevent the movement of pieces of the ampoule into container part 39e after the ampoule has been broken. The screen 42b may be seated in a circumferential groove formed in the container wall. Another filter material, such as foam sponge, fabric such as cotton, etc., may be used with or in place of the screen portion 104 of screen 42b.

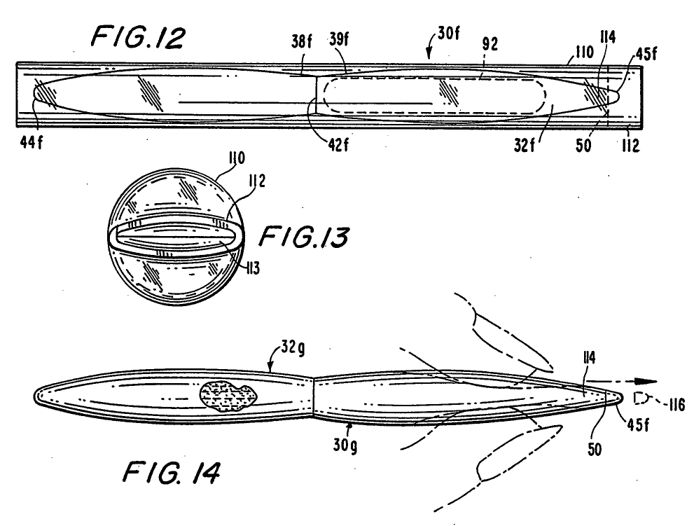

FIGS. 12-13 depict a hair-coloring system or device 30f that includes an inner container 32f and an outer container 110. Outer container 110 is self-supporting and has the flexibility or deformability discussed to allow a force, such as from squeezing, to be transmitted to the inner container 32f. The outer container is sealed at both ends. The inner container may be similar to container 32a with respect to the container parts, the hair color components and an ampoule in the container, but the ampoule 92 is positioned adjacent end 45f, the container 32f is distinctively shaped, and the container 32f need not be self-supporting. A sealing member 42f may also be provided, which also functions to limit movement of the ampoule 92 in the container. To communicate container parts 38f and 39f, the seal provided by the sealing member 42f must be broken and the ampoule 92 must be broken.

The inner container 32f (FIG. 12) may be a film or foil container, similar to disposable containers for condiments such as ketchup. The end 45f of the inner container may be conically shaped to form a spout 114 that communicates with the flattened end 112 of the outer container 110. The ends of the outer and inner containers may be snipped or cut along a weakened portion 50 (bend, tear, score) in the respective end. A cap, not shown, may be provided for the spout in the inner container, and inserted through the oval opening 114 (FIG. 13) formed in the end 112 of the outer container. The flattened end 112 of the outer container may function as a spatula.

FIG. 14 depicts a hair-coloring system or device 30g that has a container 32g that is similar to container 32f depicted in FIG. 12, except that it is grasped in use and therefore must be self-supporting. Injection molding may be used to form this and other various designs. The container 32g is shown in use being squeezed between two fingers to dispense the hair color, after mixing thereof, through the spout 114. A weakened portion 50 is provided in the end 45f to facilitate opening the spout. A cover 116 is provide to close the spout 114 to prevent leakage after the spout has been opened and while the device is not being used.

FIG. 15 depicts a hair color system or device 30h similar to device 30g depicted in FIG. 14 and including structure 72, similar to that in device 30c in FIG. 6, for attaching applicators 80 and 86 described above.

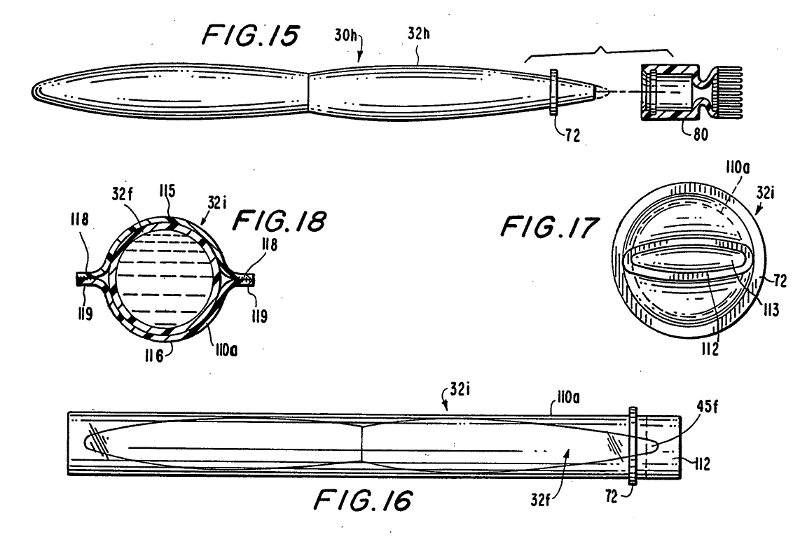

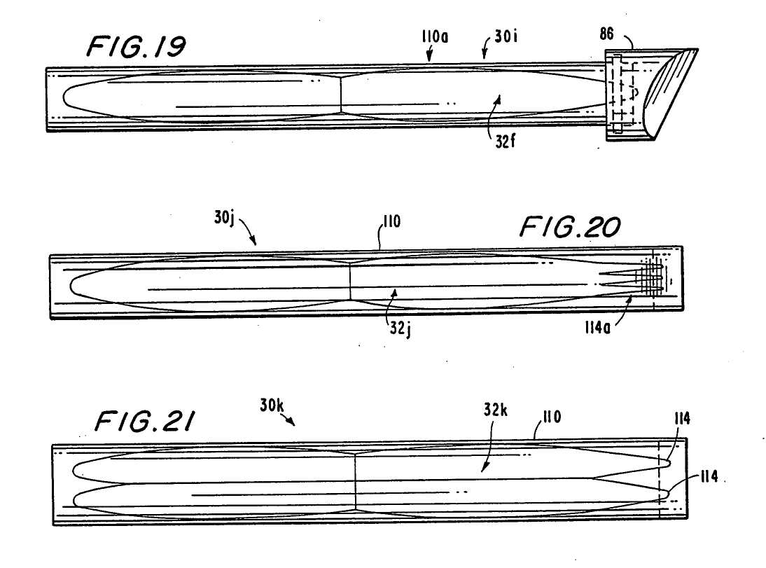

FIGS. 16-18 depict a hair color system or device 30i similar to device 30f depicted in FIG. 12 and including structure 72 on outer container 110a, similar to that in device 30c in FIG. 6, for attaching applicators 80 and 86 described above. Additionally, the outer container 110a is made from two half cylinder parts 115, 116 joined along longitudinal edges 118, 119 thereof by a heat weld or ultrasonic weld, or adhesive, etc. FIG. 19 depicts a device 32i with a sponge applicator 86 attached thereto.

FIG. 18 illustrates an embodiment of a hair-coloring dispenser with multiple directed release nozzles. Here, the plural nozzles 1810 are provided for the container 1800 to allow the hair-coloring solution to be applied to the hair. This embodiment can enable a higher flow volume of the hair-coloring solution as well as a wider flow pattern. The size and number of each nozzle should account for the expected viscosity of the hair-coloring solution and the desired flow rate and width. Additionally, the nozzle may allow the hair coloring solution to be applied in parallel streaks. The container 1800 may otherwise be constructed using the designs discussed elsewhere herein.

The hair coloring system or device 32j depicted in FIG. 20 comprise an outer container 110 and an inner container 32j, which is similar to container 32f of device 30f depicted in FIG. 12, except that container 32f has multiple spouts 114a. FIG. 21 depicts a dual hair coloring system or device 30k including an outer container 110, and a two attached inner containers 32k. Each of the inner containers 32k is similar to inner container 32f depicted in FIG. 12

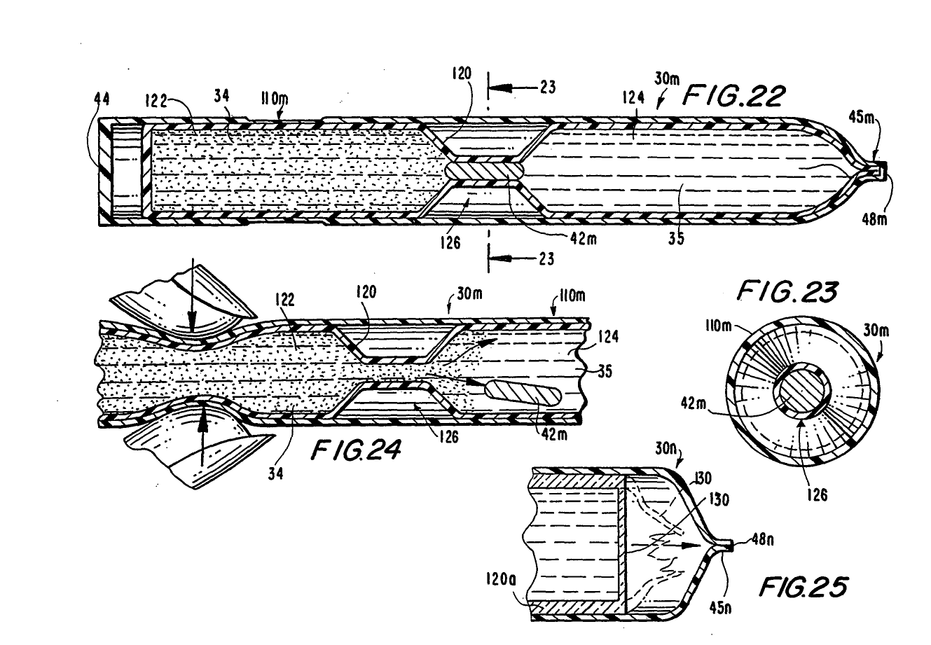

FIGS. 22-24 depict a hair-coloring system or device 30m having an inner container 120 as flaccid bag or pouch housed within a self-supporting, flexible or deformable outer container 110m. The inner container 120, which need not be self-supporting, comprises two chambers 122 and 124 for storing the two hair color components as discussed above. The chambers 122 and 124 are separated by a throat region 126 that is sealed by a sealing member 42m or sealing material such as wax or paraffin, or by other means, such as by heat sealing, etc. The bag or pouch 120 may be made of two plastic or foil sheets, for example, that are sealed along their peripheries by any suitable bonding method, e.g., heat sealing (welding), ultrasonic welding, adhesive, etc. The bag or pouch 120 can be restrained within the container, such as by securing it to the container wall using adhesive or a structural element, as discussed above, or the bag or pouch may be unrestrained.

To communicate chambers 122 and 124, the seal between the chambers is broken by moving the sealing member 42m, or opening the sealed throat in response to a squeezing action applied to either chamber (shown in FIG. 24 being applied to chamber 122.) Thereafter, the components 34 and 35 are mixed as discussed above. Labeling or other markings, such as a texture or indentation, on the container 110m may be used to indicate where to squeeze the container. After mixing, the components 34 and 35 may be expelled via a spout or nozzle 48 formed in end 45m opened by cutting the end 45m through the outer and inert containers. A wakened portion 50 may be provided to assist opening the spout 48 as discussed above.

In the end portion 45n of the device 30n depicted in FIG. 25, the end 130 of the inner container 120a terminates within a space in the end portion 45m. The end 130 is constructed to rupture upon the application of a suitable force, as described herein, to release the components within the inner container 120a into the end portion 45n, from which the components are dispensed through an opening 48n in the outer container. The inner container is constructed so that the sealing member 42m is ruptured, or other seal in the sealing region 126 is broken before the end 130 ruptures.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A self-contained hair coloring system for hair coloring applications such as touch-up, highlighting, coloring facial hair and the like, comprising a two-component hair color and an elongated container in which two components of the hair color are separately communicably stored, mixed when communicated and from which the mixed components can be dispensed directly to hair to be colored;
means for communicably separating the two components within the container and, responsive to a given force or forces applied to the container, for communicating the two components interiorly of the container such that two communicated components can be mixed in an interior region of the container; and
the container being configured to define an openable spout in communication with the interior region of the container through which the two mixed components can be applied directly from the container to hair to be colored when the spout is opened.

1a. A self-contained hair coloring system that stores and mixes in and applies hair color from entirely within a same container, the hair color including a plurality of components entirely contained within the container in an amount less than that for full head hair coloring applications for use in applications such as touch-up, highlighting, coloring facial hair and the like, comprising:
the container which is elongated and communicably holds all of the plurality of components of the hair color separated from each other, and within which the plurality of components can be communicated mixed together when communicated;
means for communicably separating each of the plurality of components within the container and, responsive to a given force or forces applied to the container, for communicating the plurality of components within the container, such that plurality of communicated components can be mixed within the container; and
an applicator attached to the container with which the hair color can be applied directly to hair to be colored when the applicator is in communication with the hair color within the container.

2. A hair coloring storage and applicator device and hair color including a plurality of components contained within the device in an amount less than that for full head hair coloring applications for use in applications such as touch-up, highlighting, coloring facial hair and the like, comprising:
an elongated container within which all the plurality of components of the hair color are communicably held separated from each other, and within which the plurality of components can be mixed together when communicated;
means for communicably separating each of the plurality of components within the container and, responsive to a given force or forces applied to the container, for communicating the plurality of components within the container, such that plurality of communicated components can be mixed within the container; and
an applicator attached to the container with which the hair color can be applied directly to hair to be colored when the applicator is in communication with the hair color within the container.

3. A hair coloring storage and applicator device hair color consisting of two components contained within the device in an amount less than that for full head hair coloring applications for use in applications such as touch-up, highlighting, coloring facial hair and the like, comprising:
an elongated closed container within which two components of the hair color are communicably held separated from each other, and within which the two components can be mixed together when communicated;
means for sealing off from each other two volumes within the container each holding a different one of the two components and for communicating the two volumes responsive to a given force applied to the container such that the first and second components can be mixed in the container; and
an applicator attached to the container with which the hair color can be applied directly to hair to be colored when the applicator is in communication with the hair coloring system within the container.

4. The device of claim 1, 2 or 3 wherein the applicator comprises an end of the container configured as a spatula.

5. The device of claim 1, 2 or 3 wherein the applicator comprises an end of the container configured as a spout.

6. The device of claim 1, 2 or 3 wherein the applicator comprises a sponge at an end of the device.

7. The device of claim 1, 2 or 3 wherein the applicator comprises a brush at an end of the device.

8. The device of claim 1, 2 or 3 wherein the applicator is attachable to an end of the device and wherein the device comprises means for attaching the applicator to the end of the device.

9. The device of claim 1, 2 or 3 wherein the container is tubular and the applicator comprises a flattened end of the container configured as a spatula.

10. The device of claim 1, 2 or 3 wherein the container is tubular and the applicator comprises a tubular end of the container of smaller diameter than that of the container configured as a spout.

11. A hair coloring storage and applicator device and a two-component hair coloring system contained within the device in an amount less than that for full head hair coloring applications for use in applications such as touch-up, highlighting, coloring facial hair and the like, comprising:
an elongated closed container within which first and second components of the two-component hair coloring system are communicably held separated from each other, and within which the two components can be mixed together when communicated;
a seal within the container which separates a first part of the container and a second part of the container;
the first part of the container holding the first component;
the second part of the container holding the second component;
the seal being breakable in response to a force applied thereto to communicate the first and second parts of the container when broken such that the first and second components can be mixed in the container; and
an applicator attached to the container with which the hair coloring system can be applied directly to hair to be colored when the applicator is in communication with the hair coloring system within the container.

12. The device of claim 11 wherein the seal comprises a movable member sealing against an inner periphery of the container and movable in response to a given force applied thereto to communicate the first and second parts of the container.

13. The device of claim 11 wherein the seal comprises a rupturable member sealing against an inner periphery of the container and rupturable in response to a given force applied thereto to communicate the first and second parts of the container.

14. A hair coloring storage and applicator device and a two-component hair coloring system contained within the device in an amount less than that for full head hair coloring applications for use in applications such as touch-up, highlighting, coloring facial hair and the like, comprising:
an elongated closed container within which first and second components of the two-component hair coloring system are communicably held separated from each other, and within which the two components can be mixed together when communicated;
a seal within the container which separates a first part of the container and a second part of the container;
the first part of the container holding the first component;
the second part of the container holding the second component;
the seal being breakable in response to a force applied thereto to communicate the first and second parts of the container when broken such that the first and second components can be mixed in the container; and
an applicator attached to the container with which the hair coloring system can be applied directly to hair to be colored when the applicator is in communication with the hair coloring system within the container.
